(19) United States
(12) Patent Application Publication
(10) Pub. No.: US 2008/0024446 A1
(43) Pub. Date: Jan. 31, 2008

(54) COMPUTER MOUSE

(75) Inventor: Zheng-Heng Sun, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/733,211

(22) Filed: Apr. 10, 2007

(30) Foreign Application Priority Data
Jul. 28, 2006 (CN) 200610061862.0

(51) Int. Cl. G06F 3/033

(52) U.S. Cl. 345/163

(57) ABSTRACT

A computer mouse includes a main body electrically connected with a computer, and a laser pointer. The main body includes two sidewalls, and a receiving space is defined in the main body bounded by the sidewalls. Each of the sidewalls defines a recess. The laser pointer is detachably mounted in the receiving space of the main body. The laser pointer includes two lateral sides, and each of the lateral sides forms a block to engage in the corresponding recess of the main body for holding the laser pointer in the receiving space of the main body.

### BACKGROUND OF THE INVENTION

1. Field of the Invention

The present invention relates to computer mouses, and more particularly to a computer mouse having a small electronic component, such as a laser pointer incorporated therein.

2. Description of Related Art

With the development of electronic technology, computers, overhead projectors, computer mouses, keyboards, and small electronic components, such as laser pointers are widely used in multimedia presentations. However, a laser pointer is relatively small, and it is easy to be lost or misplaced.

What is needed is a computer mouse having a small electronic component, such as a laser pointer incorporated therein.

### SUMMARY OF THE INVENTION

An exemplary computer mouse includes a main body electrically connected with a computer, and a laser pointer. The main body includes two sidewalls, and a receiving space is defined in the main body bounded by the sidewalls. Each of the sidewalls defines a recess. The laser pointer is detachably mounted in the receiving space of the main body. The laser pointer includes two lateral sides, and each of the lateral sides forms a block to engage in the corresponding recess of the main body for holding the laser pointer in the receiving space of the main body.

Other advantages and novel features will become more apparent from the following detailed description of preferred embodiments when taken in conjunction with the accompanying drawings, in which:

### BRIEF DESCRIPTION OF THE DRAWINGS

FIG. 1 is an assembled view of a computer mouse in accordance with a first preferred embodiment of the present invention, the computer mouse including a main body, and a laser pointer;

FIG. 2 is an exploded, isometric view of FIG. 1, but viewed from another aspect;

FIG. 3 is an exploded, isometric view of the laser pointer of FIG. 2, but viewed from another aspect; and

FIG. 4 is an exploded, isometric view of a computer mouse in accordance with a second preferred embodiment of the present invention.

### DETAILED DESCRIPTION OF THE INVENTION

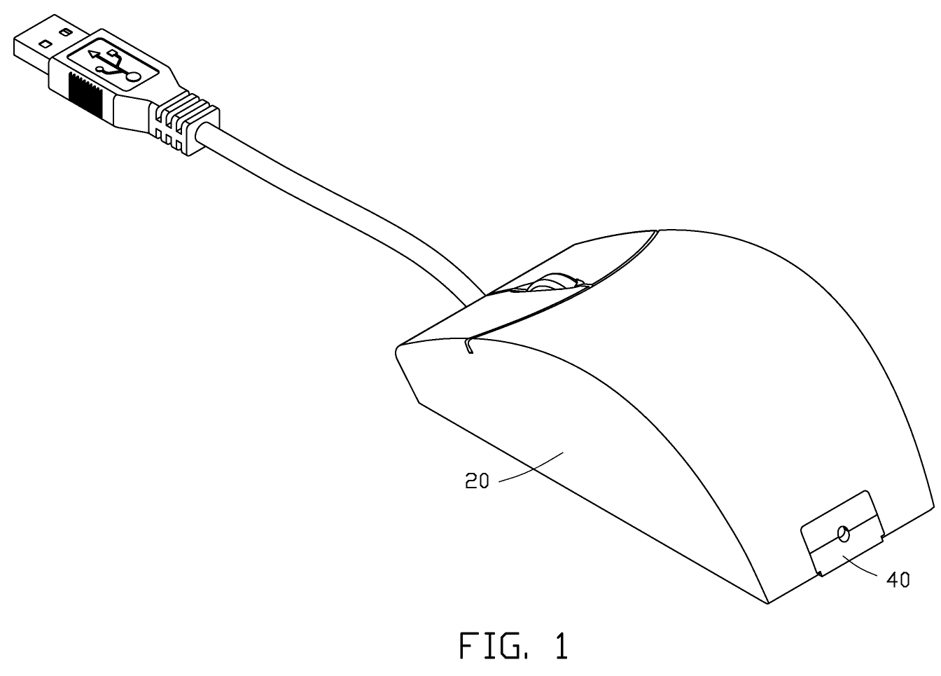

Referring to FIG. 1, a computer mouse is provided in accordance with a first preferred embodiment of the present invention. The computer mouse includes a main body 20 and a laser pointer 40.

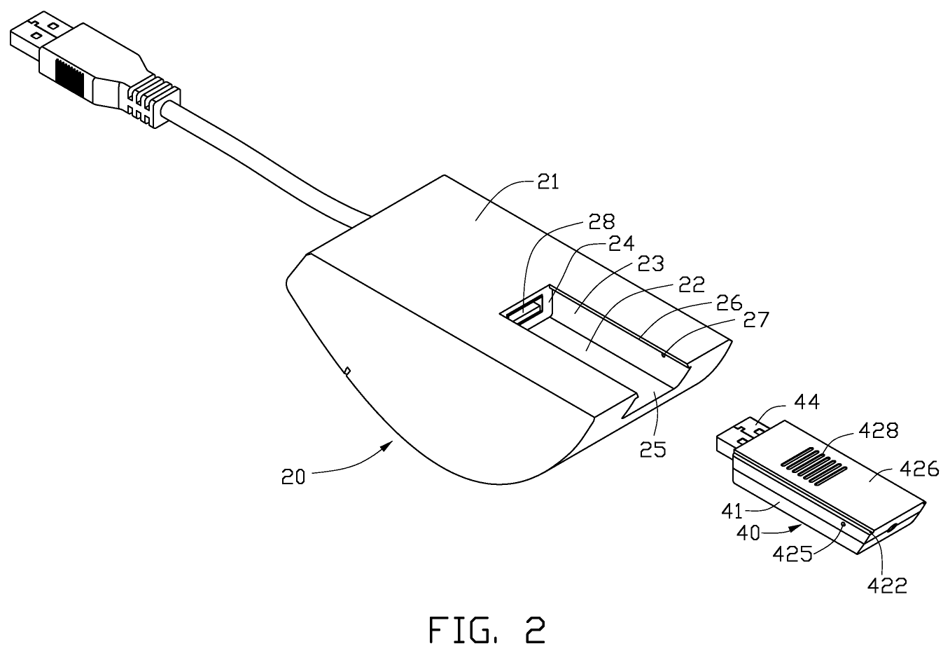

Referring to FIG. 2, the main body 20 includes a bottom wall 21. A concave receiving space 22 is defined in the bottom wall 21, and the receiving space 22 is bounded with two sidewalls 23 and an end wall 24. A pair of ribs protrudes toward each other from junctions of the sidewalls 23 and the bottom wall 21 to form a pair of sliding rails 26. An opening 25 is defined in the main body 20 at one end of the receiving space 22 opposing the end wall 24, configured for communicating the receiving space 22 to outside of the main body 20. A round recess 27 is defined in each sidewall 23 adjacent the corresponding sliding rail 26. A connector socket 28 electrically connected with a circuit board (not shown) in the main body 20 is installed in the end wall 24 adjoining the receiving space 22.

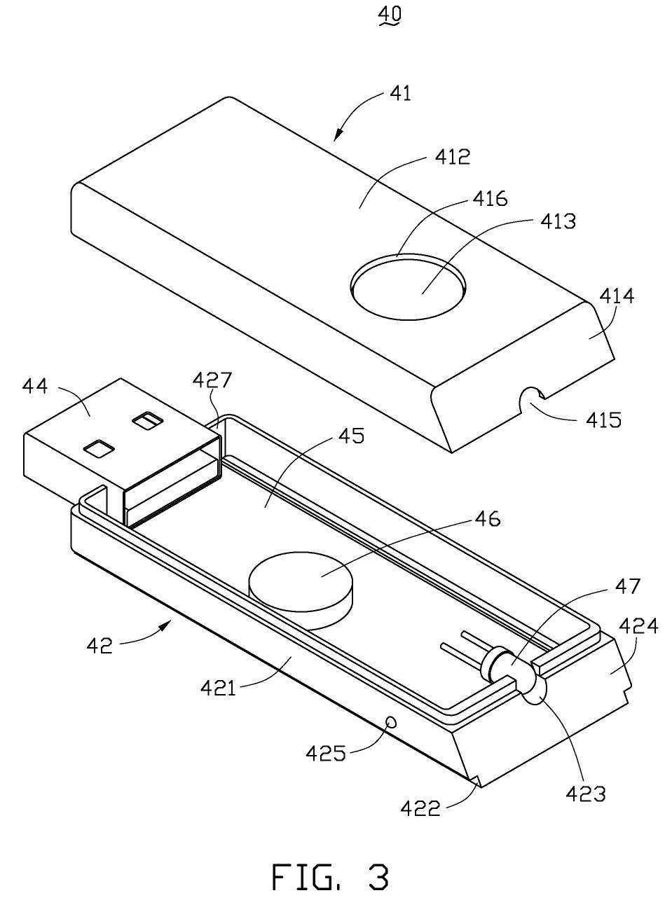

Referring also to FIG. 3, the laser pointer 40 includes a cover 41, and a base 42. The cover 41 includes a top plate 412, and an end portion 414. An aperture 416 is defined in the top plate 412 of the cover 41, and a button 413 is installed in the aperture 416 for electrically controlling the laser pointer 40. A notch 415 is defined in an edge of the end portion 414 of the cover 41. The base 42 includes two lateral sides 421, a first end portion 424, a second end portion 427, and a bottom plate 426. Each lateral side 421 defines a sliding slot 422 therein adjacent to the bottom plate 426. A block 425 protrudes from each lateral side 421 adjacent to the corresponding sliding slot 422. A notch 423 is defined in an edge of the first end portion 424 of the base 42, corresponding to the notch 415 of the cover 41. A plurality of ribs 428 is formed on an outer surface of the bottom plate 426. A circuit board 45 mounting a chargeable cell 46 thereon is installed in the base 42. A laser transmitter 47 is mounted on the circuit board 45 adjacent the notch 423 of the first end portion 424 of the base 42. A connector 44 electrically connected with the circuit board 45 is installed in the second end portion 427 of the base 42. The cover 41 is fixed to the base 42, thereby the laser pointer 40 is assembled. The notches 415, 423 cooperatively define a through hole to allow light generated by the laser transmitter 47 to pass through.

Referring back to FIG. 2, in assembly, the laser pointer 40 is pushed to slide into the receiving space 22 of the main body 20 from the opening 25, with the sliding rails 26 of the main body 20 slidably engaging with the corresponding sliding slots 422 of the base 42 of the laser pointer 40. When the connector 44 of the laser pointer 40 is entirely inserted into the connector socket 28 of the of the main body 20, the blocks 425 of the laser pointer 40 engage in the corresponding recesses 27 of the main body 20, thereby the laser pointer 40 is fixed to the main body 20, and the computer mouse is assembled. When the computer mouse is electrically connected to a power supply of a computer, the chargeable cell 46 on the circuit board 45 of the laser pointer 40 can be charged via the computer mouse.

When there is a need to use the laser pointer 40, the laser pointer 40 is detached from the main body 20. The ribs 428 on the bottom plate 426 of the laser pointer 40 are pushed by a finger of a user. The blocks 425 of the laser pointer 40 disengage from the corresponding recesses 27 of the main body 20. The laser pointer 40 is slid out from the receiving space 22 of the main body 20, and the connector 44 of the laser pointer 40 exits from the connector socket 28 of the main body 20. When the laser pointer 40 is taken out, the button 413 of the laser pointer 40 is pressed, and the laser transmitter 47 generates laser light, which passes through the through hole defined in the notches 415, 423.

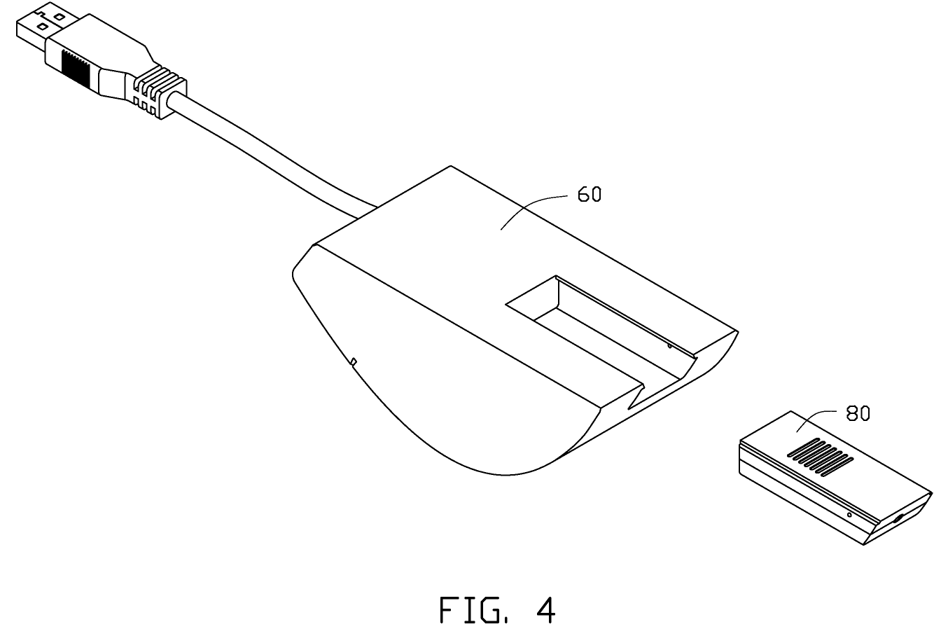

Referring to FIG. 4, a computer mouse is provided in accordance with a second preferred embodiment of the present invention. The computer mouse includes a main body 60 and a laser pointer 80, which is similar to the main body 20 and the laser pointer 40 of the first preferred embodiment respectively. The connector socket 28 of the main body 20 of the first preferred embodiment is omitted, accordingly, the connector 44 of the laser pointer 40 of the first preferred embodiment is omitted as well, and an ordinary battery rather than a chargeable cell is installed in the laser pointer 80.

In other embodiments, the connector socket 28 may be a Universal Serial Bus (USB) connector socket, and the laser pointer 40 may be replaced by other electronic devices having USB connectors, such as MPEG Audio Layer3 (MP3) players, and portable U disks.

It is believed that the present embodiments and there advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A computer mouse comprising:
a main body configured to electrically connect with a computer, the main body comprising two sidewalls, and a receiving space defined in the main body and bounded by the sidewalls, each of the sidewalls defining a recess; and
a laser pointer detachably mounted in the receiving space of the main body, the laser pointer comprising two lateral sides, and each of the lateral sides forming a block to engage in the corresponding recess of the main body for holding the laser pointer in the receiving space of the main body.

2. The computer mouse as claimed in claim 1, wherein each of the sidewalls of the main body forms a sliding rail, and each of the lateral sides of the laser pointer defines a sliding slot to allow the laser pointer to slide along the sliding rails of the sidewalls of the main body.

3. The computer mouse as claimed in claim 2, wherein the main body further comprises a bottom wall adjoining the sidewalls, the sliding rails are formed on the corresponding sidewalls adjacent to the bottom wall, the laser pointer further comprises a bottom plate, and the sliding slots are defined in the corresponding lateral sides of the laser pointer adjacent to the bottom plate.

4. The computer mouse as claimed in claim 3, wherein the bottom plate of the laser pointer forms a plurality of ribs to facilitate pushing the laser pointer out from the receiving space of the main body.

5. The computer mouse as claimed in claim 1, wherein the laser pointer further comprises a top plate, and a button is installed in the top plate for electrically controlling the laser pointer.

6. The computer mouse as claimed in claim 1, wherein the laser pointer defines a through hole therein, and a laser transmitter is installed in the laser pointer to generate laser light to pass through the through hole.

7. A computer mouse comprising:
a main body configured to electrically connect with a computer, the main body defining a receiving space therein, and a connector socket installed in the main body adjoining the receiving space; and
a laser pointer detachably mounted in the receiving space of the main body, the laser pointer comprising a chargeable cell installed therein, a connector installed in the laser pointer for electrically connecting with the connector socket of the main body to charge the chargeable cell.

8. The computer mouse as claimed in claim 7, wherein the main body comprises two sidewalls bounding the receiving space, each of the sidewalls forms a sliding rail, the laser pointer comprises two lateral sides, and each of the lateral sides defines a sliding slot to allow the laser pointer to slide along the sliding rails of the sidewalls of the main body.

9. The computer mouse as claimed in claim 8, wherein each of the sidewalls of the main body defines a recess, and each of the lateral sides of the laser pointer forms a block to engage in the corresponding recess of the main body.

10. The computer mouse as claimed in claim 8, wherein the main body further comprises a bottom wall, the receiving space is defined in the bottom wall, the sliding rails are formed on the corresponding sidewalls of the main body adjacent to the bottom wall, the laser pointer further comprises a bottom plate, and the sliding slots are defined in the corresponding lateral sides of the laser pointer adjacent to the bottom plate.

11. The computer mouse as claimed in claim 10, wherein a plurality of ribs is formed on the bottom plate to facilitate pushing the laser pointer out from the receiving space of the main body.

12. The computer mouse as claimed in claim 7, wherein the laser pointer comprises a top plate, and a button is installed in the top plate for electrically controlling the laser pointer.

13. The computer mouse as claimed in claim 7, wherein a circuit board electrically connected with the connector is installed in the laser pointer, and the chargeable cell is mounted on the circuit board.

14. The computer mouse as claimed in claim 13, wherein the laser pointer defines a through hole therein, and a laser transmitter is installed on the circuit board to generate laser light to pass through the through hole.

15. A computer mouse comprising:
a main body configured to electrically connect with a computer, the main body comprising two sidewalls, and a receiving space defined in the main body and bounded by the sidewalls;
an electronic device slidably mounted to the receiving space of the main body, the electronic device comprising two lateral sides facing the sidewalls respectively;
a pair of guiding structures formed between the sidewalls and the lateral sides configured for guiding the electronic device sliding into the receiving space; and
a locking structure formed between the sidewalls and the lateral sides configured for locking the electronic device in the receiving space.

16. The computer mouse as claimed in claim 15, wherein each of the guiding structures comprises a rail formed at one of the main body and the electronic device and a slot defined in the other one of the main body and the electronic device corresponding to the rail.

17. The computer mouse as claimed in claim 15, wherein the locking structure comprises a recess defined in one of the main body and the electronic device, and a projection formed at the other one of the main body and the electronic device configured for engaging in the recess to retain the electronic device in the receiving space of the main body.

18. The computer mouse as claimed in claim 15, wherein the main body comprises a first connector, and the electronic device comprises a chargeable cell and a second connector for electrically connecting with the first connector of the main body to charge the chargeable cell.

19. The computer mouse as claimed in claim 15, wherein the main body comprises a USB connector, and the electronic device comprises another compatible USB connector configured for electrically connecting with the USB connector of the main body to electrically connect the electronic device to the computer.

20. The computer mouse as claimed in claim 19, wherein the electronic device is a portable U disk.
